(19) United States
(12) Patent Application Publication
(10) Pub. No.: US 2026/0329089 A1
(43) Pub. Date: Oct. 22, 2026

(54) OPTICAL WAVEGUIDE STRUCTURE AND DISPLAY DEVICE

(71) Applicants: Interface Advanced Technology (Chengdu) Co., Ltd., Chengdu (CN); Interface Technology (ChengDu) Co., Ltd., Chengdu (CN); INTERFACE OPTOELECTRONICS (SHENZHEN) CO., LTD., Shenzhen (CN); GENERAL INTERFACE SOLUTION LIMITED, Zhunan (TW)

(72) Inventors: PO-LUN CHEN, Zhunan (TW); YUN-PEI CHEN, Zhunan (TW); KUN-DA LU, Zhunan (TW)

(21) Appl. No.: 19/468,052

(22) Filed: Feb. 3, 2026

Related U.S. Application Data
(63) Continuation-in-part of application No. PCT/CN2025/086148, filed on Mar. 31, 2025.

(51) Int. Cl. G02B 27/01; G02B 6/32; G02B 6/34; G02B 27/00

(52) U.S. Cl. CPC G02B 27/0172; G02B 6/32; G02B 6/34; G02B 27/0037; G02B 2027/011; G02B 2027/0178

(57) ABSTRACT

An optical waveguide structure includes: a waveguide used to guide an image light; a coupling-out grating on a surface of the waveguide and used to coupling the image light out of the waveguide; and a first lens on a side of the waveguide and on a light path of ambient light, wherein the first lens includes a first optical surface facing away from the waveguide, the first optical surface is a freeform surface having asymmetric curvature and is used to adjust a focus point of the ambient light, a direction of the first lens transmitting the image light is consistent with a direction of the coupling-out grating coupling out the image light. A display device is also provided.

### FIELD

The present disclosure relates to display technique, and particularly relates to an optical waveguide structure and a display device including the optical waveguide structure.

### BACKGROUND

Augmented reality (AR) display devices combine virtual image with real-world visuals, enabling users to interact with digital content naturally. Current AR display devices can easily cause eye strain, users with myopia, hyperopia, or astigmatism may have poor experiences suing the AR display.

### BRIEF DESCRIPTION OF DRAWINGS

FIG. 1 is a perspective schematic diagram of a display device according to a first embodiment of the present disclosure.

FIG. 2 is a schematic diagram of an optical system shown in FIG. 1.

FIG. 3 is a planar view of an optical waveguide structure shown in FIG. 2.

FIG. 4 is a schematic diagram showing different regions of a first lens shown in FIG. 3.

FIG. 5 is a schematic diagram showing a twisting force of astigmatic human eyes on light.

FIG. 6 is a schematic diagram showing an optical path of light after the light path is corrected by the optical waveguide structure of the present disclosure.

FIG. 7 shows an optical waveguide structure according to a second embodiment of the present disclosure.

FIG. 8 is a planar view of the optical waveguide structure shown in FIG. 7.

### DETAILED DESCRIPTION

The technical solutions in the embodiments of the present disclosure will be described clearly and completely below in conjunction with the accompanying drawings. It is apparent that the described embodiments represent only a portion rather than all embodiments of the present disclosure.

Traditional AR displays (such as AR glasses) include optical waveguides. Optical signals can undergo multiple total reflections in the optical waveguide and then coupled out of the waveguide. In the AR displays, by coupling an image light into the optical waveguide, the image light can be transmitted to the front of human eye through the optical waveguide and then projected onto the human eye for imaging.

An image observed by a user wearing the AR glass forms a virtual image at infinity, while objects in a real environment may be located nearby. Therefore, when observing AR images, the user needs to switch between different focus positions, leading to eye fatigue.

In addition, for users with refractive errors such as myopia, hyperopia, astigmatism, etc., the AR displays have poor display effects.

An optical waveguide structure and a display device including the optical waveguide structure provided in the embodiments of the present disclosure, by adding a lens in front of the human eye and designing a surface shape (such as curvature) of the lens reasonably, is conducive to improving an user experience of the users having refractive error, especially to improving a visual effect of astigmatism users.

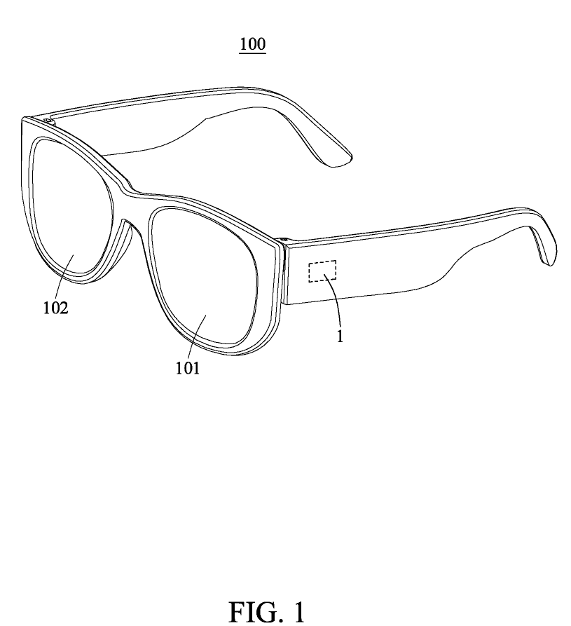

Referring to FIG. 1, a display device 100 of the present embodiment is an AR glass. When an user wears the display device 100 to the head, the user's eyes can observe a projected image displayed by the display device 100. At the same time, an ambient light from a real world can also enter the human eye through the display device 100, allowing the human eye to observe an image of real world. By combining the image of real world with the projected image displayed by the display device 100, the human eye can observe the projected image overlaying on the image of real world, also known as an AR image.

The display device 100 includes an optical system 101 and an optical system 102 that have essentially the same structure and function. The optical system 101 corresponds to a left lens, configured for imaging for the user's left eye, and the optical system 102 corresponds to a right lens, configured for imaging for the user's right eye. In at least one embodiment, image light projected by optical system 101 and image light projected by optical system 102 have different polarization directions, allowing the human eye to observe a stereoscopic image.

The following describes the structure and function of the optical system 101 as an example.

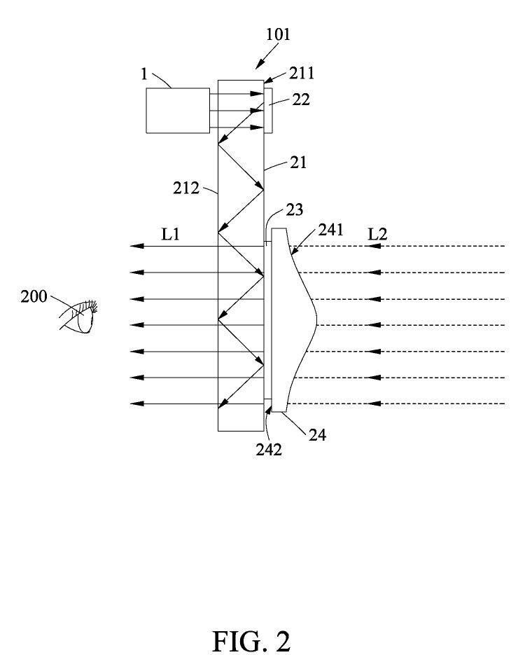

Referring to FIGS. 1 and 2, the optical system 101 includes a micro-display 1 and an optical waveguide structure 2. The micro-display 1 is used to image light L1, the optical waveguide structure 2 is on a light path of the image light L1 and is used to guide the image light and project the image light to an eye box of the user to display image.

The micro-display 1 can be embedded at a side of a glass leg connecting a glass frame and having a size not exceed 3 inches. The micro-display 1 can be a mini light-emitting diode (Mini LED) micro-display, a micro light-emitting diode (Micro LED) micro-display, an organic light emitting diode (OLED) micro display, etc. The image light L1 emitted by the micro-display 1 can include light beams in three wavelength bands: red, green, and blue, to present a color image.

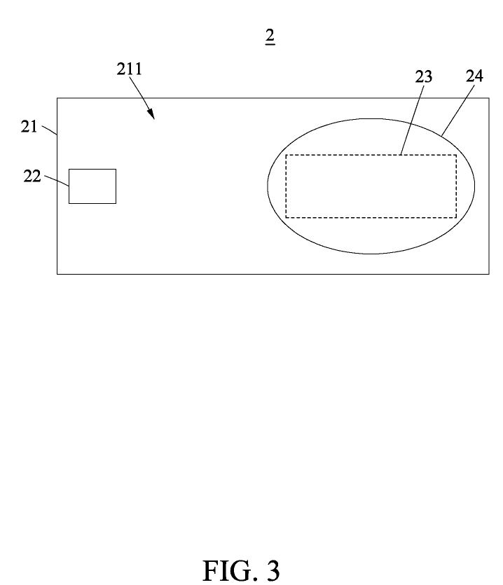

The optical waveguide structure 2 can be positioned at the lens, for example, the optical waveguide structure 2 is embedded inside the lens. Referring to FIGS. 2 and 3, the optical waveguide structure 2 includes an optical waveguide 21, a coupling-in grating 22, and a coupling-out grating 23. The optical waveguide 21 is a thin sheet-like structure with a first surface 211 and a second surface 212 spaced and parallel to each other. The coupling-in grating 22 and the coupling-out grating 23 are on the first surface 211 and are spaced apart from each other.

The coupling-in grating 22 is used to couple the image light L1 emitted by the micro-display 1 into the optical waveguide 21. The image light L1 undergoes multiple total reflections in the optical waveguide 21, propagating from the coupling-in grating 22 towards the coupling-out grating 23. The coupling-out grating 23 is used to diffract and reflect the received image light L1, so that the image light L1 is coupled out from the second surface 212 of the optical waveguide 21.

The optical waveguide 21 can include materials such as optical glass and optical resin. The coupling-in grating 22 and the coupling-out grating 23 can be, for example, surface relief gratings or holographic volume gratings.

The optical waveguide structure also includes a first lens 24 on a side of the coupling-out grating 23 away from the optical waveguide 21. That is, the coupling-out grating 23 is between the optical waveguide 21 and the first lens 24. When the user wears the display device 100, the ambient light L2 enters the optical waveguide structure 2 from the first lens 24. That is, the ambient light L2 sequentially passes through the first lens 24, the coupling-out grating 23, and the optical waveguide 21 before entering the user's eye box.

The first lens 24 is used to converge the ambient light L2. A focal position of the ambient light L2 can be adjusted by adjusting values of optical parameters of the first lens 24. In this embodiment of the present disclosure, a shape of a surface of the first lens 24 is set to make the focal positions (i.e. focal points) of meridians in different directions of the ambient light L2 tend to be consistent. Specifically, the first lens 24 includes a first optical surface 241 facing away from the coupling-out grating 23. The first optical surface 241 is set to be a free-form surface with asymmetric curvature to make the focal positions (i.e. focal points) of the meridians in different directions of the ambient light L2 tend to be consistent.

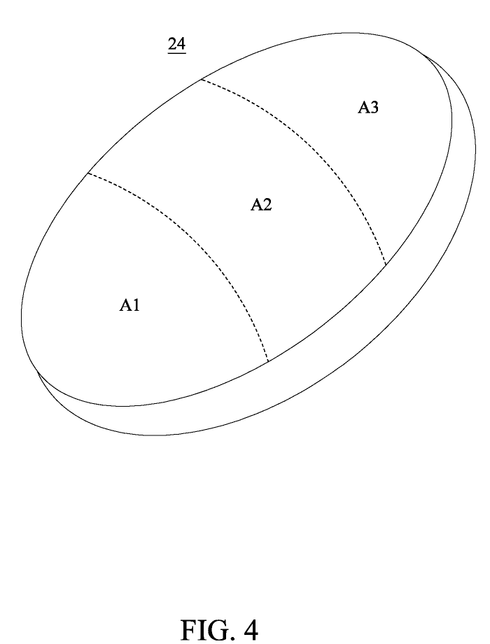

Referring to FIG. 4, in at least one embodiment of the present disclosure, the first optical surface 241 of the first lens 24 has sequentially spliced a first region A1, a second region A2, and a third region A3, wherein an optical axis of the first lens 24 intersects with the second region A2. Curvatures of the first region A1, the second region A2, and the third region A3 are different, resulting in different bending forces of the first region A1, the second region A2, and the third region A3 on the ambient light L2. For example, the first region A1 corresponds to an eye area with astigmatism power of 1.2 D, the second region A2 corresponds to an eye area with astigmatism power of 0.9 D, and the third region A3 corresponds to an eye area with astigmatism power of 0.6 D.

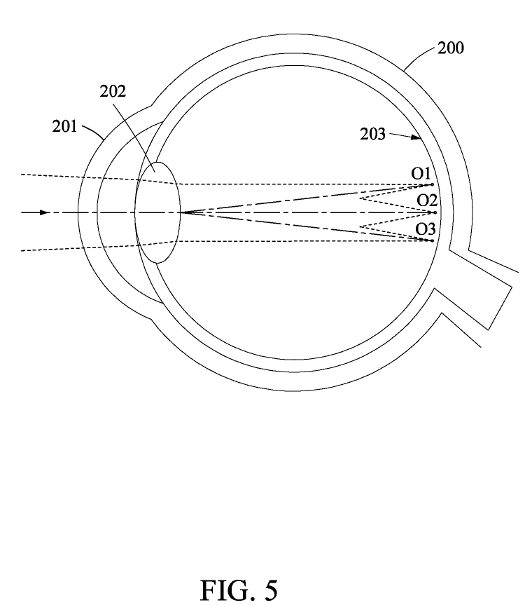

Referring to FIG. 5, the astigmatism in the human eye is mainly caused by uneven surface curvature of a cornea 201 or a lens 202. When parallel lights enter the eye, due to the uneven surface curvature of the cornea 201 or the lens 202, there are significant differences in refractive powers of meridians in different directions, causing the lights to focus on multiple focal points O1, O2, and O3 after passing through the cornea 201 and the lens 202, and unable to form a single focal point on a posterior retina 203, resulting in a blurred or ghosted visual effect in the human eye 200.

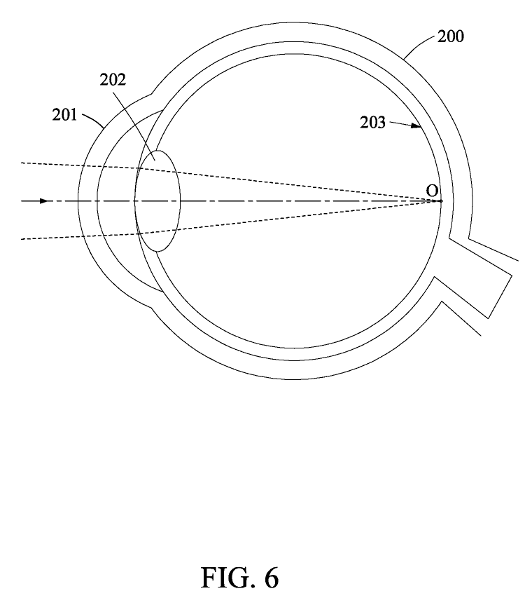

Referring to FIG. 6, in the optical waveguide structure of the present embodiment, by designing the first optical surface 241 of the first lens 24 as a free-form surface with asymmetric curvature, it is possible to compensate for the difference in refractive powers of the human eye 200 in different meridian directions, so that the optical system composed of the first lens 24, the cornea, and the lens tends to have consistent refractive power in different directions of meridians. Therefore, when the meridians in various directions of ambient light L2 pass through the first lens 24, the cornea 201, and the lens 202 successively, they all focus on a same focal point O (or tend to focus on the same focal point O). In this way, it can avoid blurring or ghosting caused by the ambient light L2 focusing on multiple different positions. That is, in the optical waveguide structure of the present embodiment, the curvature of the first optical surface 241 of the first lens 24 is designed to achieve an effect of correcting the astigmatism in the human eye.

Usually, a degree and a mode of astigmatism in the human eye can be evaluated based on the following parameters: astigmatism power, astigmatism axis, and astigmatism type. The astigmatism power, measured in diopter (D), represents the degree of irregularity in the refractive power of the cornea or lens of the human eye. The astigmatism axis, marked in degrees ranging from 0° to 180°, represents a direction of strongest astigmatism. The astigmatism axis directly affects a design of corrective lenses, and common classifications of the astigmatism axis include: compliant astigmatism which has anaxial lies within a range of 180°± 30°, reverse astigmatism which has an axial lies within a range of 90°± 30°, and oblique axis astigmatism which has an axial lies within a range of 30° to 60° or 120° to 150°. Types of astigmatism include: regular astigmatism that the corneal or crystalline lens refractive surface exhibits symmetrical irregularity and irregular astigmatism that the refractive surface exhibits misalignment (such as corneal scars, keratoconus, etc.).

The specific surface design of the first optical surface 241 of the first lens 24 and the specific optical parameter design of the first lens 24 are customized according to the degree and mode of astigmatism of the human eye, which is consistent with an optical design of an astigmatism correction lens. In this way, the first lens 24 can correct the astigmatism defect of the human eye, and the image light L1 transmitted through the first lens 24 tends to have a single focus, presenting a clear image, which is conducive to improving the user experience.

Referring to FIGS. 2 and 3, the first lens 24 is a positive lens used to converge light. The first lens 24 is a plano convex lens, and the first optical surface 241 is a convex surface facing away from the human eye 200. The first lens 24 also includes a second optical surface 242 facing the coupling-out grating 23 and parallel to the first surface 211 of the optical waveguide 21, wherein the second optical surface 242 directly contacts the coupling-out grating 23. The first lens 24 can be a glass or plastic lens, and the first lens 24 can be a spherical lens or a non-spherical lens.

An orthographic projection of the first lens 24 on the optical waveguide 21 completely covers the coupling-out grating 23. That is, an orthographic projection of the first optical surface 241 on the optical waveguide 21 completely covers the coupling-out grating 23. In this way, both the image light L1 coupled out of the coupling-out grating 23 and the ambient light L2 transmitted through the first lens 24 can be projected into the eye box and received by the human eye 200, displaying the AR image together.

In at least one embodiment of the present disclosure, the optical waveguide structure 2 may further include a fixing structure (not shown) for installing and fixing the first lens 24. In this embodiment, the first lens 24 includes a mounting portion and an effective optical portion. The effective optical portion is a central area of the first lens 24, and the mounting portion surrounds a periphery of the effective optical portion for overlapping the fixed structure.

In this embodiment, the installation portion does not act on the ambient light L2. The ambient light L2 is incident on the effective optical portion, and an orthographic projection of the effective optical portion of the first lens 24 on the optical waveguide 21 completely covers the coupling-out grating 23, which can achieve that both the image light L1 coupled out of the coupling-out grating 23 and the ambient light L2 transmitted through the first lens 24 can be projected into the eye box and received by the human eye 200, jointly displaying the AR image.

In the embodiments shown in FIGS. 2 and 3, the first lens 24 is not only used to correct human eye astigmatism, but also to correct human eye hyperopia. Hyperopia in the human eye refers to a visual effect where light is focused behind the retina after passing through the cornea and the lens, and cannot be precisely focused on the retina, resulting in blurry images. By converging the image light L1 through the first lens 24, the focus of the image light L1 can be moved forward, and it can be precisely focused on the retina, presenting a clear image. A specific degree of convergence of the first lens 24 on the image light L1 is determined by a farsightedness of the user wearing the AR glass.

In the optical systems shown in FIGS. 2 and 3, the coupling-out grating 23 is a reflective grating. In at least one modified embodiment, the coupling-out grating 23 can also be a transmissive grating. In the modified embodiment, the coupling-out grating 23 is on the second surface 212 of the optical waveguide 21, and a position relationship between the first lens 24 and the coupling-out grating 23 remains unchanged.

In the modified embodiment, the image light L1 is incident on the coupling-out grating 23, transmitted through the coupling-out grating 23 to the first lens 24, and then transmitted through the first lens 24 to the human eye 200. The ambient light L2 enters from the first surface 211 of the optical waveguide 21, passes through the optical waveguide 21, the coupling-out grating 23, and the first lens 24 in sequence, and enters the eye box, presenting the AR image together with the image light L1.In the modified embodiment, the coupling-in grating 22 can also be positioned on the second surface 212.

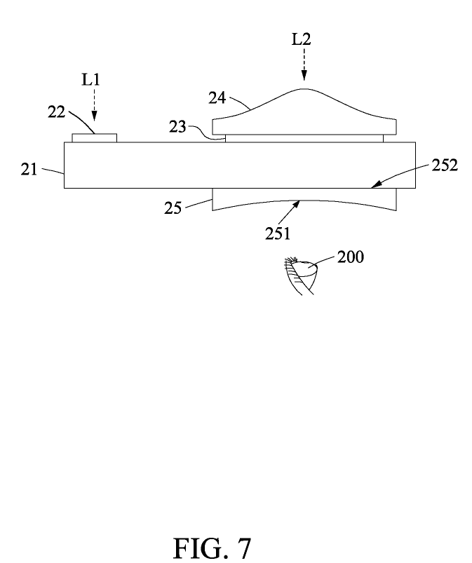

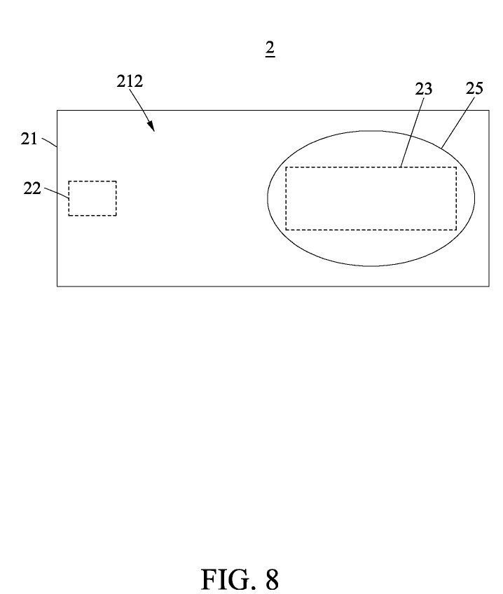

Referring to FIGS. 7 and 8, in a second embodiment of the present disclosure, the optical waveguide structure further includes a second lens 25, and the optical waveguide 21 is between the first lens 24 and the second lens 25. The coupling-out grating 23 is a reflective grating as shown in FIGS. 2 and 3.

The second lens 25 is a negative lens that diverges light. Specifically, the second lens 25 is a plano concave lens and includes an opposing third optical surface 251 and a fourth optical surface 252. The third optical surface 251 is a concave surface facing away from the waveguide 21, and the fourth optical surface 252 is a plane parallel to the second surface 212 of the waveguide 21, wherein the fourth optical surface 252 directly contact the second surface 212. The fourth optical surface 252 is between the third optical surface 251 and the optical waveguide 21. The third optical surface 251 faces towards the human eye 200. The second lens 25 can be a glass or plastic lens.

Myopia in the human eye refers to a visual effect where light passes through the cornea and lens and is focused in front of the retina, but cannot be precisely focused on the retina, resulting in blurry images. By diverging the ambient light L2 through the second lens 25, the focus of the image light L1 can be moved backwards, allowing it to be precisely focused on the retina and presenting a clear image. The specific degree of convergence of the image light L1 by the second lens 25 is determined by the degree of myopia of the user wearing the AR glass.

In this second embodiment, the second lens 25 is on the second surface 212 of the optical waveguide 21, that is, the optical waveguide 21 is between the first lens 24 and the second lens 25. By adjusting a spacing between the first lens 24 and the second lens 25, a spacing between the first lens 24 and the optical waveguide 21, a spacing between the second lens 25 and the optical waveguide 21, optical parameters of the first lens 24 and the second lens 25, the specific convergence position (i.e. focus) of the ambient light L2 after passing through the second lens 25 can be adjusted to match the degree of refractive error of the human eye. Therefore, compared to the display devices 100 shown in FIGS. 2 and 3, the display devices 100 shown in FIGS. 7 and 8 can also be used to correct myopia in addition to correcting astigmatism and farsightedness.

The optical waveguide structure 2 and the display device 100 including the optical waveguide structure 2 of the present embodiment can correct astigmatism and farsightedness and improve image display effect by reasonably designing the curvature of the first optical surface 241 of the first lens 24. On this basis, by setting the second lens 25 to cooperate with the first lens 24 to adjust the system focus, it is also possible to correct myopia and improve the image display effect. In summary, the optical waveguide structure 2 and the display device 100 including the optical waveguide structure 2 of the present embodiment are beneficial for correcting various refractive errors such as astigmatism, myopia, and hyperopia, and can improve the image display effect for users.

The embodiments shown and described above are only examples. Many details are often found in the art such as the other features of a light-emitting assembly and a display device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An optical waveguide structure comprising:
a waveguide configured to guide an image light;
a coupling-out grating on a surface of the waveguide and configured to coupling the image light out of the waveguide; and
a first lens on a side of the waveguide and on a light path of ambient light, wherein the first lens comprises a first optical surface facing away from the waveguide, the first optical surface is a freeform surface having an asymmetric curvature and is configured to adjust a focus point of the ambient light, a direction of the first lens transmitting the image light is consistent with a direction of the coupling-out grating coupling out the image light.

2. The optical waveguide structure according to claim 1, wherein the first lens is a positive lens and the first optical surface is a convex surface.

3. The optical waveguide structure according to claim 1, wherein the first optical surface comprises at least a first region and a second region with different curvatures, and the first region and the second region are configured to correct respective degrees of astigmatism of a human eye.

4. The optical waveguide structure according to claim 1, wherein the first lens further comprises a second optical surface facing the coupling-out grating and parallel to the surface of the optical waveguide.

5. The optical waveguide structure according to claim 1, further comprising a second lens on one side of the optical waveguide, wherein the second lens is a negative lens, and the first lens and the second lens are configured to jointly adjust a focal length of the optical waveguide structure.

6. The optical waveguide structure according to claim 5, wherein an optical surface of the second lens facing away from the optical waveguide is a concave surface.

7. The optical waveguide structure according to claim 1, wherein the first lens is on the side of the optical waveguide having the coupling-out grating.

8. The optical waveguide structure according to claim 1, wherein the coupling-out grating is configured to reflect the image light out of the optical waveguide.

9. A display device, characterized by comprising:
a micro display configured to emit image light; and
an optical waveguide structure comprising:
a waveguide configured to guide an image light;
a coupling-out grating on a surface of the waveguide and configured to coupling the image light out of the waveguide; and
a first lens on a side of the waveguide and on a light path of ambient light, wherein the first lens comprises a first optical surface facing away from the waveguide, the first optical surface is a freeform surface having an asymmetric curvature and is configured to adjust a focus point of the ambient light, a direction of the first lens transmitting the image light is consistent with a direction of the coupling-out grating coupling out the image light; and
the coupling-out grating is configured to couple the image light into an eye box, the first lens is configured to transmit the ambient light into the eye box, and the image light and the ambient light are configured to jointly present an AR image.

10. The optical waveguide structure according to claim 9, wherein the first lens is a positive lens and the first optical surface is a convex surface.

11. The optical waveguide structure according to claim 9, wherein the first optical surface comprises at least a first region and a second region with different curvatures, and the first region and the second region are configured to correct respective degrees of astigmatism of a human eye.

12. The optical waveguide structure according to claim 9, wherein the first lens further comprises a second optical surface facing the coupling-out grating and parallel to the surface of the optical waveguide.

13. The optical waveguide structure according to claim 9, further comprising a second lens on one side of the optical waveguide, wherein the second lens is a negative lens, and the first lens and the second lens are configured to jointly adjust a focal length of the optical waveguide structure.

14. The optical waveguide structure according to claim 13, wherein an optical surface of the second lens facing away from the optical waveguide is a concave surface.

15. The optical waveguide structure according to claim 9, wherein the first lens is on the side of the optical waveguide having the coupling-out grating.

16. The optical waveguide structure according to claim 9, wherein the coupling-out grating is configured to reflect the image light out of the optical waveguide.

17. The display device according to claim 9, wherein the display device comprises two independent optical systems, and each of the two independent optical systems comprises the micro display and the optical waveguide structure.
